(19) United States
(12) Patent Application Publication
(10) Pub. No.: US 2005/0060692 A1
(43) Pub. Date: Mar. 17, 2005

(54) Method and apparatus for reducing time to generate a build for a software product from source-files

(76) Inventor: Nikolai Mansourov, Nepean (CA)

Correspondence Address: SMART & BIGGAR;P.O. Box 2999, Station D, 900-55 Metcalfe Street, Ottawa, ON, K1P 5Y6, CA

(21) Appl. No.: 10/662,464

(22) Filed: Sep. 16, 2003

(51) Int. Cl. G06F 9/45

(52) U.S. Cl. 717/141; 717/152

(57) ABSTRACT

Source code, for example source code written in C or C++, typically includes comment lines in header files. Comment lines are included in source-files by developers to assist in the comprehension of the code by a person reading the code. However, the comments have no bearing whatsoever upon the function of the code. It has been found that when the overall build process is considered, the amount of time that is taken to process a comment line can be significant. According to the invention, in order to reduce build time, the comments are removed from the included header files prior to the compilation process

### FIELD OF THE INVENTION

The invention relates to the process of compiling software products from source-files, and in particular to methods and apparatus for reducing the time taken to generate a new build for these products.

### BACKGROUND OF THE INVENTION

Software products are made up of software executables, which are in turn derived from source-files in a process commonly referred to as generating a (new) build. Generating a build for a software product from the source-files often consumes significant resources. Many organisations prefer to generate new builds frequently, or even continuously. Therefore, it is desirable to reduce the time it takes to generate a build for a software product from its source-files.

A motivation in software design is modularity. That is, software developers are motivated to design complex software products not as a whole but as a number of functional blocks (or modules) that can be linked together. At the compilation level, this is often realized by the separate compilation of source-files, where a software product is made up of a number of source-files that are each treated as a separate compilation unit. Each compilation unit (i.e. source-file) is compiled separately from the others into an intermediate representation, often referred to as an object file. The object files are then assembled into a final product, in a process known as linking. In order to ensure proper assembly of the separately compiled units into the final product, the compiler requires access to some information about the related compilation units.

In some programming languages, for example C and C++, the information about compilation units (also called implementation files) is usually placed in what is known as header files. Header files define common symbols and/or functions that are common to a group of compilation units. For example, definitions and declarations that are shared among one or more of the implementation files as well as other header files. Header files are made available to related compilation units by reading the corresponding header files into the current compilation unit as it is being compiled with the help of a programming language preprocessor (e.g. a C/C++ preprocessor) that is part of the programming language's design. This process is referred to as the inclusion of the header file. Specifically, in regard to C and C++, the C/C++ preprocessor follows the #include<header_file_name> directives.

The division and composition of implementation files and header files that make up a software product (i.e. its source-files, written in a programming language like C/C++) can be considered the structural or physical architecture of a software product. The implementation and header files are commonly referred to as the source-files of a software product. Software developers tend to focus on the logical or functional architecture of the software rather than the physical architecture. The logical architecture describes the composition of software into classes, subsystems, layers and modules.

Referring to FIG. 1, shown is an example schematic of a physical architecture. Shown are a number of implementation files 10, 12 (only 2 shown), and a set of header files 14. The set of header files 14 is shown to include three files 16, 18 and 20. Using the #include< >directive, implementation file 10 is shown to include the header file 16 which in turn includes each of the header files 18 and 20. Similarly, the implementation file 12 is shown to include the header file 18.

The process of generating a build for a software product includes a step of compiling the implementation files (typically, one-by-one) during which process a compiler reads an implementation file and then respective included header files following the corresponding #include< >directives of the C/C++ language. Every time a header file is included in another file it must be processed. For example, a header file that is included in ten source-files must be processed ten different times. As a result, the effect of these #include< >directives is an expansion in the number of the code lines that need to be compiled.

To quantify the compilation process, one can define a compile expansion metric that is a ratio of the number of lines of code processed by the compiler to the actual number of lines of code present in the source-files. To see the effect of the header files on the compile expansion metric, first consider a software product consisting of 300 implementation files, each having one thousand lines of code but having no included header files. The total number of lines of code compiled in the compilation process would be 300×1000=300,000. In this case, the compile expansion metric is equal to 1, because the total number of lines of code in the source-files is equal to the number of lines processed in the compilation process.

Now consider that each implementation file includes a single header file, which contains 500 lines of code. Now, the total number of lines of code in the source-files is 1000×300+500=300, 500. However, the total number of lines of code processed in the compilation process is (1000+500)×300=450,000 lines of code. The compile expansion metric is (450,000/300, 500)=1.5.

A typical software development process is shown in FIGS. 2A and 2B. FIG. 2A shows the development activity at step 2A-1 during which developers sign out various modules (i.e. source-files), make amendments, and then submit them to a Configuration Management (CM) tool/system. The configuration management tool/system as indicated at step 2A-2, and is responsible for making sure that during the next generation of a build, the most recent version of each software module are included.

A very high level view of what happens during the generation of a build is shown in FIG. 2B. At step 2B-1, the source-files are extracted, and in the event that the configuration management tool/system is in place they are extracted from configuration management tool/system. This is followed by a pre-processing/auto generation, step 2B-2. Step 2B-2 is not to be confused with the function of a programming language pre-processor (e.g. C/C++ pre-processor) described above, which is part of the programming language. Step 2B-2 is followed step 2B-3 in which there is a complete compilation of the source-files to generate corresponding object files. At step 2B-4, the object files generated in the previous compilation step are used to generate executables in what was referred to above as a linking phase. The output of the linking phase is commonly known as a (new) build for the software product.

It is noted that the generation of a build for a complex software product may take several hours to several days to complete. This can have a significant affect upon the progress of a project, and any mechanism that can be provided to reduce this time would be of benefit. It has been found that the time taken to generate a build is highly correlated with the compile expansion metric, and as such a reduction in the compile expansion metric typically results in a corresponding reduction in the time required to generate a build.

Several approaches have been developed to improve the physical architecture of software products in order to reduce the compile expansion metric and consequently the time required to generate a build.

One common way to reduce the time taken to generate a build is to preserve all object files from the previous build generation, re-compile only as few compilation units (i.e. source-files) as absolutely necessary and then link all of the object files. The compilation units that need to be re-compiled are the ones that were modified since the last time a build was generated, as well as those ones that depend on the modified ones (usually—modified header files). A drawback to this approach is that it requires precise definition of the dependencies between source-files.

Another way to reduce the time required to generate a build is to use libraries storing source files and corresponding object files. Source-files are compiled once then the resulting object files are arranged into the libraries and linked into several products. This approach is limited to situations where there is a large number of executables to be built. Also, this approach is limited to reusing the common link units, such as function definitions, while other important symbols like macro definitions and types exist only at the compilation phase where the executables are generated.

Other approaches involve improvement of the source-files. Some approaches analyse the physical architecture and suggest ways to optimize it. In order to improve the physical architecture, one can make a total inventory of the usage relations and compare them to the include relations between files. Accordingly, one can remove unnecessary include directives. For example, when a header file is included but no symbols are used from this file, the included file can be safely removed. One can also remove transitive include directives. This occurs when a header file is included, no symbols are used from this file, but the file includes some other header file from which symbols are used. When removing transitive header files, the other files should be directly included into the files that use it. However, this may actually increase the compile expansion metric.

In addition to these methods, other approaches are possible. For example, one can try to split header files if different groups of files use non-overlapping sets of symbols from the header.

The above methods are error prone, and often require significant effort from the development team.

### SUMMARY OF THE INVENTION

According to a first aspect of an embodiment of the invention there is provided a processor implemented method of generating a build for a software product from one or more source-files. The method comprises processing each of the one or more source-files to remove comment lines from said source file to produce a respective compacted source file; and compiling each of the one or more compacted source-files to generate a new build of the software product.

In some embodiments of the invention the processor implemented method further comprises, for each of the one or more source files, a step of determining whether or not it is sufficiently beneficial to remove comment lines from said source file, and if it is not sufficiently beneficial not removing the comment lines from said source file in a subsequent iteration of the method. In such embodiments the processor implemented method may further comprise a step of counting comment lines in each of the one or more source files and the number of times each of the one or more source files is included in another of the one or more source-files, wherein the step of determining whether or not it is sufficiently beneficial to remove comment lines from a particular source file is based on the number of comment lines in the particular source file and the number of times that particular source file is included in another of the one or more source files.

Also according to other embodiments of the processor implemented method, between the generation of successive builds, the method may include adaptively selecting which of the one or more source-files to be processed for comment removal.

In yet other embodiments of the invention the processor implemented method may further comprise for each of the one or more source-files generating comment expansion statistics, wherein determining whether or not it is sufficiently beneficial to remove comment lines from a particular source file is based on the comment expansion statistics for that particular source file.

According to another broad aspect of an embodiment according to the invention there is provided an apparatus for generating a build for a software product from one or more source-files. The apparatus comprises a comment extraction program adapted to process each of the one or more source-files to remove comment lines from said source file to produce a respective compacted source file; and a compiler adapted to compile each of the one or more compacted source-files to generate a new build of the software product.

In some embodiments the apparatus may also include a code repository in which the one or more source-files and the respective compacted source files are stored.

In other embodiment the apparatus may include a pre-processor for pre-processing each of the one or more compacted source-files before the compiler compiles each of the one or more source files. Alternatively, the apparatus may include a pre-processor for pre-processing each of the one or more source files before the comment extraction program removes the comment lines to produce the respective compacted source-file.

In yet other embodiments the apparatus may also comprise an extraction program adapted for removing each of the one or more source-files from the code repository. In such embodiments the extraction program and the comment extraction program may be integrated with one another so that as each of the one or more source-files is removed from the code repository comment lines in each of the one or more source-files are removed.

According to another broad aspect of the invention there is provided a computer readable medium having instructions stored thereon for implementing a method of generating a build for a software product made-up of one or more source-files. The method comprises processing each of the one or more source-files to remove comment lines from said source file to produce a respective compacted source file; and compiling each of the one or more compacted source-files to generate a new build of the software product.

### BRIEF DESCRIPTION OF THE DRAWINGS

Preferred embodiments of the invention will now be described with reference to the attached drawings in which:

FIG. 1 is an example schematic of a physical architecture of a software project;

FIGS. 2A and 2B provide high level flow charts of a typical software development process and a build generation process, respectively;

FIG. 3 is a logical view of an embodiment of the invention;

FIGS. 4A and 4B are flow charts of two methods of implementing the embodiment of FIG. 3;

FIG. 5 is a detailed flow chart of a preferred method of extracting comments from C/C++ code; and

FIG. 6 is a flow chart of a method of processing code to remove comment lines which is adaptive in nature.

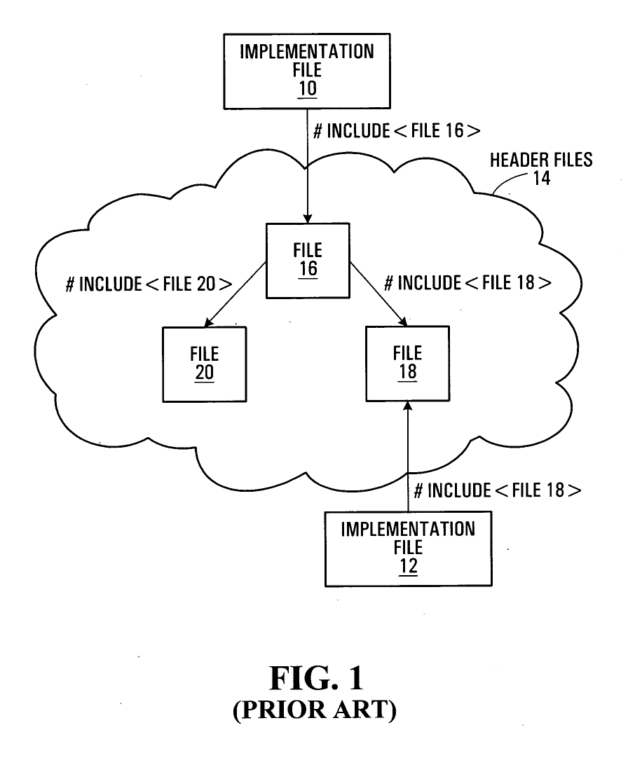

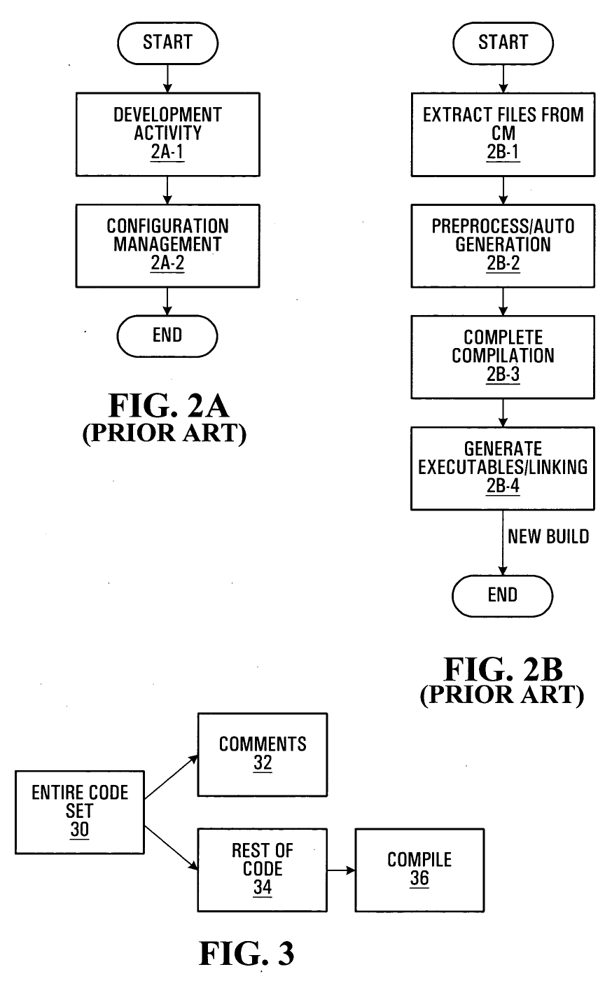

### DETAILED DESCRIPTION OF THE PREFERRED EMBODIMENTS

As discussed above, the compile expansion metric is highly correlated with the build time.

Source code, for example source code written in C or C++, typically contains comment lines in header files. Comment lines are included in source-files by developers to assist in the comprehension of the code by a person reading the code. However, the comments have no bearing whatsoever upon the function of the code. It has been found that when the overall process of generating a build is considered, the amount of time that is taken to process a comment line can be significant.

Furthermore, a comment line in a header file will have its effect multiplied due to the fact that the same header file is included in multiple source-files, and as such the same header file is processed many times. For example, consider the example introduced in the Background of the Invention section in which there are 300 implementation files each containing 1000 lines of code and each of which includes a single header file. Consider for example that the header file has a 10 line comment. This single 10 line comment will contribute to 10×300=3000 lines of code that the C/C++ compiler will have to process. This is equivalent to 0.7% of the lines the compiler processes. A 100 line comment would contribute 100×300=30,000 lines of code. This is equivalent to 6.7% of the total number of lines of code the compiler processes.

According to the invention, in order to reduce the time required to generate a build, the source-files (including header files) are compacted by removing comments immediately prior to the compilation step. [where did compaction term come from?]

Referring to FIG. 3, a logical view of this embodiment of the invention is shown. An input to the process is the entire code set indicated at 30. The entire code set 30 consists of all the implementation files and the header files that contribute to the make-up of a software product. The entire code set 30 is processed to remove all of the comments, generally indicated at 32 leaving only the rest of the code 34 which is then compiled at 36. It is noted that the set of comments 32 does not need to be maintained, but rather these are simply discarded as they are extracted from the code.

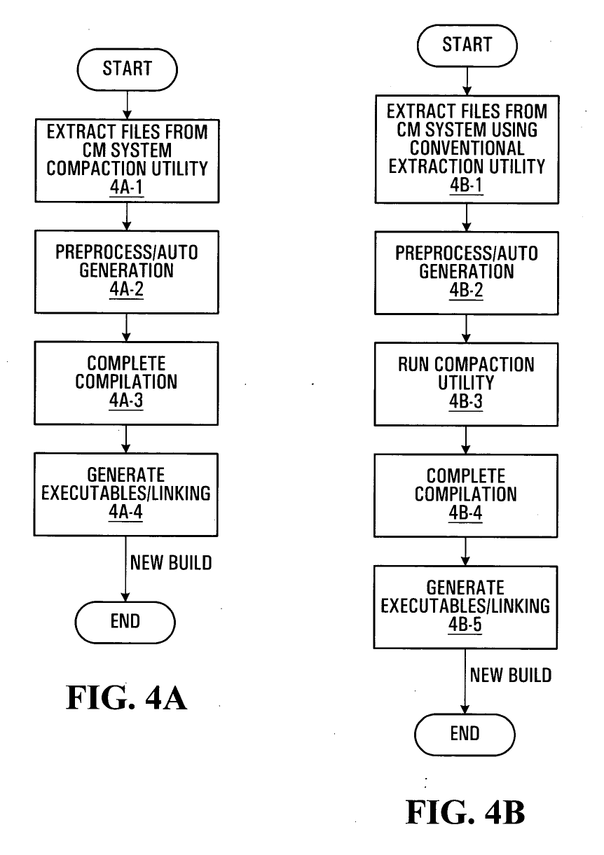

There are several possible strategies to integrate a compaction utility into the process of generating a build. For example, the compaction utility can be combined with an extraction utility/process of the configuration management tool/system. Alternatively, the compaction utility can follow the pre-processing of the source-files by the compiler. The second strategy is more general, and may also be more beneficial, because it will compact the automatically generated files. Below both approaches are described in more detail with reference to FIGS. 4A and 4B.

Referring now to FIG. 4A, shown is a first flow chart of a method of generating a build for a software product provided by an embodiment of the invention. The method begins at step 4A-1 with the extraction of source-files from a Configuration Management (CM) tool/system using a compaction utility provided by the invention. The compaction utility is combined with an extraction utility (possibly provided by the configuration management tool/system) and thus as each source-file is extracted the comments are removed to produce a respective compacted source-file. The source-files thus processed are then passed forward to the normal pre-process/auto-generation and complete compilation steps 4A-2, 4A-3, respectively.

It is noted that some configuration management tools/systems in the process of storing an edited software module add a significant amount of commentary to the beginning of the file, which indicates the complete file amendment history. These lines of comments add even further to the problem identified previously beyond the comment added by the software developer. Thus, the configuration management tools/systems are adding to the time taken to complete a generation of a build. By including an extraction utility in combination with a compaction utility which extracts these files and at the same time removes all of the comments, the functionality of the configuration tool/system is enhanced, and the resulting time taken to generate a build is reduced.

In order to implement the method provided by the invention described above, in some embodiments the configuration management tool/system differentiates between extraction of source-files for the compilation purposes, and extraction of source-files for the editing purposes.

FIG. 4B is a flow chart of a second method. In this embodiment the source-files are extracted at step 4B-1 using a conventional extraction utility from the configuration management tool/system. Next, step 4B-2 is a conventional pre-process/auto-generation function. Then the compaction utility provided by this embodiment of the invention is run at step 4B-3 to remove the comment lines. The step 4B-3 is followed by the complete compilation steps and linking phase 4B-4 and 4B-5, respectively.

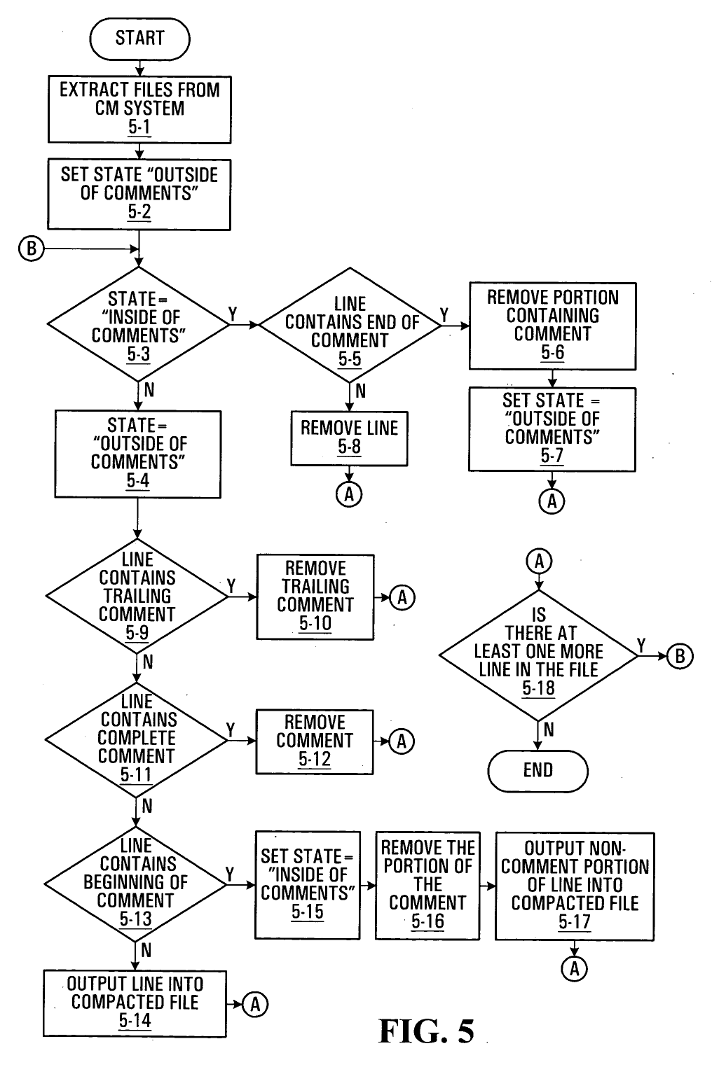

FIG. 5 is a flow chart of a detailed implementation for removing comments from C/C++ code according to a method provided by an embodiment of the invention. To begin a source file is extracted at step 5-1 and a state (flag) is set to indicate “outside of comments”, meaning that the method has not yet encountered the beginning of a comment.

Moving on one line at a time within the source file it is determined at step 5-3 whether or not the state is “inside of comments”. That is, the question of “Can or has the beginning of a comment been identified?” is answered. If the beginning of a comment can not been identified (no path, 5-3) then the method moves on to step 5-4 in which it is confirmed that the state is “outside the comment”. On the other hand, if the beginning of a comment is identified (yes path, 5-3), then the method moves on to step 5-5.

During step 5-5 it is determined whether or not the present line contains the end of the comment identified in step 5-3. If the present line contains the end of the comment (yes path, 5-5) then the portion of the line containing the comment is removed and the state is set to “outside of comment” in steps 5-6 and 5-7, respectively. On the other hand, if the line does not contain the end of the comment (no path 5-5) the entire line is removed at step 5-8.

Returning to step 5-4, step 5-4 is followed by step 5-9 in which it is determined whether or not the present line contains a trailing comment. If the line contains a trailing comment (yes path 5-9) then the trailing comment is removed in step 5-10. On the other hand if the present line does not contain a training comment (no path 5-9) the method moves on to step 5-11.

At step 5-11 it is determined whether or not the present line contains a complete comment. If the present line contains a complete comment (yes path 5-11) then the comment is removed at step 5-12. On the other hand, if the line does not contain a complete comment (no path 5-11) the method moves on to step 5-13.

At step 5-13 it is determined whether or not the present line contains the beginning of a comment. If the line does not contain the beginning of a comment (no path 5-13) the entire line is output into a respective compacted source file at step 5-14. On the other hand, if the line does contain the beginning of a comment (yes path 5-13) the state is set to “inside of comment”, the portion of the line containing the comment is removed and the non-comment portion is outputted into the respective compacted file at steps 5-15, 5-16 and 5-17, respectively.

After steps 5-7, 5-8, 5-10, 5-12, 5-14 and 5-17 it is determined at step 5-18 whether or not there is at least one more line of code left in the source-file. If there are no more lines of code (no path 5-18) then the method terminates. On the other hand if there is at least one more line of code in the source-file (yes path 5-18) then the method resumes starting at step 5-3.

The method according to an embodiment of the invention described above has the effect of decreasing the compile expansion metric. As discussed, this typically results in a corresponding decrease in the time required to generate a build. However, it is of course to be understood that the process of removing the comment lines will add to the time required to generate a build. As such, the total effect will be the conventional build time minus the savings in the build time by not having to process comments, plus the time taken to process the header files in the first place to remove the comments.

In another embodiment of the invention, the compaction utility is configured to only operate upon files for which there will be a substantial reduction in build time. This determination is made over the course of at least one previous build.

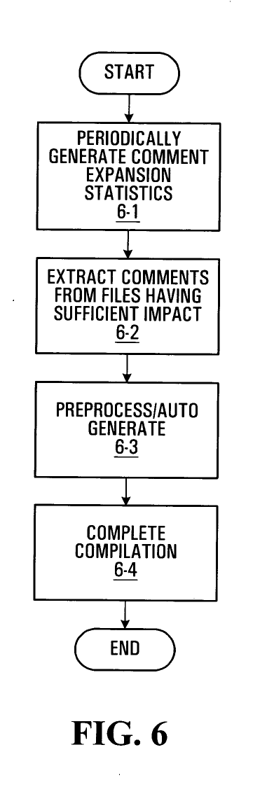

Referring to FIG. 6, shown is a flow chart of this embodiment of the invention. To begin, as shown at step 6-1, the entire code set is periodically processed to generate comment expansion statistics. This involves determining for each header file how frequently the header file is included, and how many comment lines there are in the header file. The product between these two values gives an indication of how many lines of code the header file contributes to the final total.

At step 6-2, the compaction utility is applied only to files that are determined to have sufficient impact upon the number of lines of code. For example, the above noted product between the number of time a header file is included and the number of comment lines in the header file can be compared to a threshold, with the method only being executed for header files that exceed the threshold.

Step 6-2 is followed by the pre-processing/auto-generation and complete compilation steps 6-3 and 6-4, respectively. It is noted that the comment expansion statistics will typically not change rapidly from one compilation to the next. Accordingly, the comment expansion statistics do not necessarily need to be updated after every build is generated and this will result in savings of processing time compared to generating the comment expansion statistics after every build is generated. However, in other implementations it might be useful to generate the comment expansion statistics after every build is generated.

A threshold that would be used to determine whether or not to remove the comments from a particular source-file would be an implementation specific value.

In one embodiment, the above discussed comment extraction utility is included as part of a configuration management tool/system. In another embodiment, the utility could be included as part of a compiler. In yet another embodiment, the utility could be provided as a standalone product capable of processing code to generate an output that is more suitable for compilation. Preferably, the utility is provided in the form of software. This can be stored in a computer readable medium together with configuration management software and/or compiler software for example or can be provided on its own computer readable medium. Alternatively, the utility can be implemented in hardware, or in a combination of hardware and software.

In the above-described embodiments a configuration management too/system is used in combination with the methods provided by an embodiment of the invention. However, it would be clear to those skilled in the art that in alternative embodiments of the invention the method provided could be combined with a code depository of a more general design than the configuration management tool/system described above.

It will be apparent to those skilled in this art that various modifications and variations may be made to the embodiments disclosed herein, consistent with the present invention, without departing from the spirit and scope of the present invention.

1. A processor implemented method of generating a build for a software product from one or more source-files, the method comprising:
i) processing each of the one or more source-files to remove comment lines from said source file to produce a respective compacted source file; and
ii) compiling each of the one or more compacted source-files to generate a new build of the software product.

2. The processor implemented method according to claim 1 further comprising, for each of the one or more source files, a step of determining whether or not it is sufficiently beneficial to remove comment lines from said source file, and if it is not sufficiently beneficial not removing the comment lines from said source file in a subsequent iteration of the method.

3. The processor implemented method according to claim 1 adapted for use with C/C++.

4. The processor implemented method according to claim 1 adapted for use with a programming language which supports modular program construction through compile time processing of the one or more source-files.

5. The processor implemented method according to claim 2 further comprising a step of counting comment lines in each of the one or more source files and the number of times each of the one or more source files is included in another of the one or more source-files, wherein the step of determining whether or not it is sufficiently beneficial to remove comment lines from a particular source file is based on the number of comment lines in the particular source file and the number of times that particular source file is included in another of the one or more source files.

6. A method according of claim 1 further comprising between the generation of successive builds, adaptively selecting which source-files to be processed for comment removal.

7. The method according to claim 2 further comprising for each of the one or more source-files generating comment expansion statistics, wherein the step of determining whether or not it is sufficiently beneficial to remove comment lines from a particular source file is based on the comment expansion statistics for that particular source file.

8. The method according to claim 7 wherein the comment expansion statistics are generated periodically for each of the one or more source files.

9. An apparatus for generating a build for a software product from one or more source-files, the apparatus comprising:
i) a comment extraction program adapted to process each of the one or more source-files to remove comment lines from said source file to produce a respective compacted source file; and
ii) a compiler adapted to compile each of the one or more compacted source-files to generate a new build of the software product.

10. The apparatus of claim 9 further comprising a code repository in which the one or more source-files and the respective compacted source files are stored.

11. The apparatus of claim 9 further comprising a pre-processor for pre-processing each of the one or more compacted source-files before the compiler compiles.

12. The apparatus of claim 9 further comprising a pre-processor for pre-processing each of the one or more source files before the comment extraction program removes the comment lines to produce the respective compacted source-file.

13. The apparatus of claim 10 further comprising an extraction program adapted to remove each of the one or more source-files from the code repository.

14. The apparatus of claim 13, wherein the extraction program and the comment extraction program are integrated with one another so that as each of the one or more source-files is removed from the code repository comment lines in each of the one or more source-files are removed.

15. A computer readable medium having instructions stored thereon for implementing a method of generating a build for a software product made-up of one or more source-files, the method comprising:
i) processing each of the one or more source-files to remove comment lines from said source file to produce a respective compacted source file; and
ii) compiling each of the one or more compacted source-files to generate a new build of the software product.

16. The computer readable medium of claim 15, wherein the method further comprises for each of the one or more source files determining whether or not it is sufficiently beneficial to remove comment lines from said source file, and if it is not sufficiently beneficial not removing the comment lines from said source file in a subsequent iteration of the method.

17. The computer readable medium of claim 16, wherein the method further comprises counting comment lines within each of the one or more source files and the number of times each of the one or more source files is included in another of the one or more source-files, wherein determining whether or not it is sufficiently beneficial to remove comment lines from a particular source file is based on the number of comment lines in the particular source file and the number of times that particular source file is included in another of the one or more source files.

18. The computer readable medium of claim 15, wherein the method further comprises, between the generation of successive builds, adaptively selecting which source-files to be processed for comment line removal.

19. The computer readable medium of claim 16, wherein the method further comprises for each of the one or more source-files generating comment expansion statistics, wherein determining whether or not it is sufficiently beneficial to remove comment lines from a particular source file is based on the comment expansion statistics for that particular source file.

20. The computer readable medium of claim 19, wherein for the method the comment expansion statistics are generated periodically for each of the one or more source files.
